(19) United States
(12) Patent Application Publication
(10) Pub. No.: US 2020/0302521 A1
(43) Pub. Date: Sep. 24, 2020

(54) METHOD AND SYSTEM FOR SOFTWARE MONITORING ASSOCIATED WITH AN ENTITY

(71) Applicant: Intuit Inc., Mountain View, CA (US)

(72) Inventor: Daniel Wernikoff, Portola Valley, CA (US)

(73) Assignee: Intuit Inc., Mountain View, CA (US)

(21) Appl. No.: 16/865,114

(22) Filed: May 1, 2020

Related U.S. Application Data
(63) Continuation of application No. 11/929,932, filed on Oct. 30, 2007, now abandoned.

(51) Int. Cl. G06Q 40/02; G06Q 40/00

(52) U.S. Cl. CPC G06Q 40/02; G06Q 40/00

(57) ABSTRACT

A method for assessing financial risk associated with a business entity involves recording usage data associated with a consumer business software, where the usage data describes consumer behavior associated with the consumer business software, and where the consumer business software is associated with a business entity. The method further involves generating a financial risk assessment associated with the business entity based on the usage data, and determining an approval status based on the financial risk assessment, where the approval status indicates whether the business entity is approved to receive a financial service.

### CROSS BENEFIT TO RELATED APPLICATIONS

This application is a continuation of U.S. patent application Ser. No. 11/929,932, filed Oct. 30, 2007. Accordingly, this application claims benefit under 35 U.S.C. § 120 to U.S. patent application Ser. No. 11/929,932. U.S. patent application Ser. No. 11/929,932 is incorporated herein by reference in its entirety.

### BACKGROUND

The domestic and global marketplaces include many different types of business entities such as a sole proprietorship, a corporation, a limited liability partnership (LLP), a limited liability company (LLC), a reseller, an independent contractor, a consultant, and other forms of business organizations. Many of these business entities subscribe to financial services such as merchant accounts, corporate credit cards, and banking services. The infrastructure for providing such services would be prohibitively time-consuming and expensive for most business entities to implement independently.

When providing these services, financial service providers generally prefer to deal with business entities in good financial standing. Specifically, financial service providers prefer to avoid situations where business entities might default on fees associated with financial services. For example, when a business entity subscribes to a merchant account, the interchange fees associated with high-volume transactions can be considerable. However, the business entity may go bankrupt before paying those fees. In such cases, the financial services provider effectively acts as an underwriter and assumes financial responsibility for the unpaid fees. Some business entities even engage in fraud, taking advantage of financial services without ever intending to pay the associated fees. For example, a business entity may attempt to avoid fees by assuming a fraudulent identity.

To avoid having to assume these financial responsibilities, financial service providers generally designate financial criteria that business entities must satisfy before receiving financial services. Often, these criteria are evaluated using a lengthy application process, which requires large amounts of human data entry and review. Financial service providers typically see a drop-off in business proportional to the length and difficulty of the application process. Seeking to reduce the barrier to attracting business, the application process is commonly shortened. However, a shorter application process provides less information about business entities and therefore increases the risk of providing financial services to financially insecure or fraudulent business entities.

### SUMMARY

In general, in one aspect, the invention relates to a method for assessing financial risk associated with a business entity. The method comprises recording a plurality of usage data associated with a consumer business software, wherein the plurality of usage data describes consumer behavior associated with the consumer business software, and wherein the consumer business software is associated with a business entity. The method further comprises generating a financial risk assessment associated with the business entity based on the plurality of usage data, and determining an approval status based on the financial risk assessment, wherein the approval status indicates whether the business entity is approved to receive a financial service.

In general, in one aspect, the invention relates to a computer system. The computer system comprises a consumer business software associated with a business entity, and a risk assessment service. The risk assessment service is configured to obtain a plurality of usage data associated with the consumer business software, wherein the plurality of usage data describes consumer behavior associated with the consumer business software. The risk assessment is further configured to generate a financial risk assessment associated with the business entity based on the plurality of usage data, and determine an approval status based on the financial risk assessment, wherein the approval status indicates whether the business entity is approved to receive a financial service.

In general, in one aspect, the invention relates to a computer-readable medium comprising executable instructions for assessing financial risk associated with a business entity. The executable instructions comprise instructions to record a plurality of usage data associated with a consumer business software, wherein the plurality of usage data describes consumer behavior associated with the consumer business software. The executable instructions further comprise instructions to generate a financial risk assessment associated with the business entity based on the plurality of usage data, and determine an approval status based on the financial risk assessment, wherein the approval status indicates whether the business entity is approved to receive a financial service.

Other aspects of the invention will be apparent from the following description and the appended claims.

### BRIEF DESCRIPTION OF DRAWINGS

FIG. 1 shows a diagram of a system in accordance with one or more embodiments of the invention.

FIG. 2 shows a flowchart of a method for assessing financial risk associated with a business entity in accordance with one or more embodiments of the invention.

FIG. 3 shows a diagram of a computer system in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

In general, embodiments of the invention provide a method and system for assessing financial risk associated with a business entity. Usage data associated with consumer business software is recorded and used to generate a financial risk assessment associated with a business entity. The financial risk assessment is then used to determine whether the business entity is approved to receive a particular financial service.

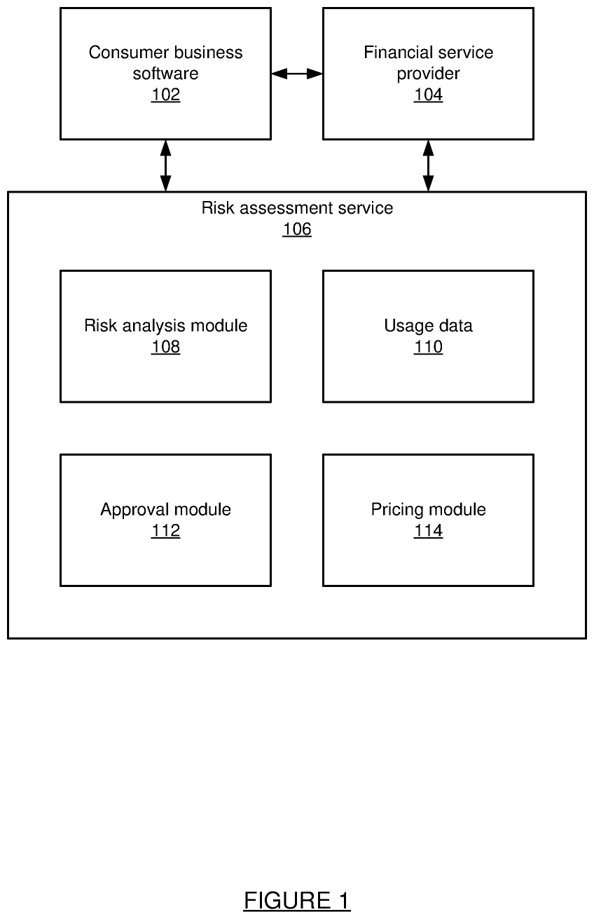

FIG. 1 shows a diagram of a system in accordance with one or more embodiments of the invention. The system includes consumer business software (102) associated with a business entity. The consumer business software (102) may be any type of software, such as application software installed on a personal computer, client-server software installed on a business network, or an Internet-based application such as a website.

Whatever type of software is used, the term “consumer” means that the consumer business software (102) is licensed to a business consumer. Specifically, the consumer business software (102) is licensed to the business entity or a designated agent thereof (for example, an accountant or tax specialist). In other words, the business entity or designated agent is a “consumer” of the consumer business software (102). To further illustrate this concept, the Fair Isaac Corporation (FICO) would not be considered a “consumer” in this context, because FICO's primary customers are financial service providers. In other words, FICO is an agent of the financial service providers, not an agent of the business entities to which financial services are provided.

Further, the term “business” indicates that the consumer business software (102) includes business functionality related one or more of the business entity's operations. Examples of business functionality include accounting, human resources, payroll, banking, customer relationship management (CRM), supply chain management, business reporting, point-of-sale transactions, and project management. Generally speaking, the consumer business software (102) may be any type of software configured to store and/or process business data related to the business entity's operations. For example, the business data may include records of purchases, records of sales, tax information, employee records, payroll information, banking information, or inventory logs.

As noted above, the consumer business software (102) is licensed to the business entity or a designated agent thereof. For the purposes of this discussion, “licensing” refers to the broad category of legal and financial agreements that may be required to use the consumer business software (102). In some cases, the licensee may be required to purchase a license prior to using the consumer business software (102). For example, the cost of the license may depend on the number of authorized users or installed copies of the consumer business software (102). Further, the licensee may be required to explicitly or implicitly agree to terms of use associated with the consumer business software (102). For example, even if the consumer business software (102) does not require a paid license, the consumer business software (102) may include an End-User License Agreement (EULA), which for the purposes of this discussion would be considered a license. Those skilled in the art will appreciate that many different legal and financial licensing schemes exist and are contemplated by this invention.

Continuing with discussion of FIG. 1, in one or more embodiments, the system includes a financial service provider (104). The financial service provider (104) includes the infrastructure (for example, employees, computer systems, networks, and workflow) and knowledge necessary for providing financial services to business entities. In one or more embodiments, the consumer business software (102) includes functionality to submit an application to the financial service provider (104), i.e., an application for the business entity to receive a financial service from the financial service provider (104). In one or more embodiments, the consumer business software (102) is configured to submit the application in electronic form. Alternatively, the consumer business software (102) may be configured to print the application on paper, so the application can be mailed to the financial service provider (104). Further, because the consumer business software (102) includes business data associated with the business entity, the consumer business software (102) may be configured to pre-populate the application using the business data.

Further, the system includes a risk assessment service (106). The risk assessment service (106) is configured to generate a financial risk assessment associated with the business entity. Specifically, the financial risk assessment is an assessment of risk for a particular business entity (or type/class of business entity) based on usage data (110) associated with the consumer business software (102). Further, in one or more embodiments, the risk assessment service (106) is configured to determine whether a business entity is approved to receive a financial service based on the generated financial risk assessment. The risk assessment service (106) may also be configured to price the financial service for the business entity based on the generated financial risk assessment.

As noted above, the financial risk assessment is based on usage data (110) associated with consumer business software (102). Specifically, the usage data (110) describes consumer behavior associated with the consumer business software (102). Many different types of consumer behaviors may be recorded, and examples of consumer behaviors are discussed below. Further, the usage data (110) may be recorded in many different ways. For example, the risk assessment service (106) may include a monitoring module (not shown) configured to monitor usage of the consumer business software (102). Alternatively, the consumer business software (102) may be configured to obtain the usage data (110) and transmit the usage data (110) to the risk assessment service (110). For example, if the consumer business software (102) is a website, an underlying web server may be configured to record Uniform Resource Locators (URLs) visited by users of the website.

The usage data (110) may be stored in a database, a text file, an extensible markup language (XML) file, a spreadsheet, or any other type of data storage. In FIG. 1, the usage data (110) is shown stored within the risk assessment service (106). Alternatively, the usage data (110) may be stored within the consumer business software (102) or in another location in an accessible form.

In one or more embodiments, the risk assessment service (106) includes multiple hardware and/or software modules (for example, integrated circuits, executable files, object classes, or data structures) configured to perform the functionality discussed above. For example, the functionality may be divided between a risk analysis module (108), an approval module (112), and a pricing module (114). Each of these modules is discussed in detail below.

In one or more embodiments, the risk analysis module (108) is configured to generate the financial risk assessment based on the usage data (110). Further, in one or more embodiments, the approval module (112) is configured to determine the business entity's approval status (i.e., whether the business entity is approved to receive the financial service) based on the financial risk assessment generated by the risk analysis module (108). In one or more embodiments, the approval module (112) is configured to determine the approval status without human intervention. Alternatively, the approval module (112) may require additional review (i.e., a human review, analysis using artificial intelligence and/or a neural network, etc.) of the approval status before the business entity is officially approved to receive the financial service. In one or more embodiments, the pricing module (114) is configured to price the financial service for the business entity. For example, a business entity receiving a low financial risk assessment may be entitled to a lower price than a business entity receiving a high financial risk assessment.

As discussed above, the risk assessment service (106) may use the financial risk assessment to determine whether to approve the business entity to receive a financial service. Further, in one or more embodiments, the risk assessment service (106) is configured to communicate the approval status to the financial service provider (104). In turn, the financial service provider (104) may be configured to notify the business entity of the approval status. In one or more embodiments, the financial service provider (104) includes functionality to notify the business entity of the approval status via the consumer business software (102), for example using an email, popup message, or another type of alert.

In one or more embodiments, the financial service provider (104) is configured to notify the business entity of the approval status even if the business entity has not applied for the financial service. In other words, the risk assessment service (106) may be configured to help the financial service provider (104) pre-approve the business entity to receive the financial service. In one or more embodiments, this type of pre-approval allows the financial service provider (104) to target financial services at desirable customers (i.e., financially viable business entities). Alternatively, the financial service provider (104) may be configured to simply store the approval status in case the business entity ever applies to receive the financial service. As still another alternative, the risk assessment service (106) may be configured to only determine the approval status after the business entity applies to receive the financial service, thereby supplementing existing application processes.

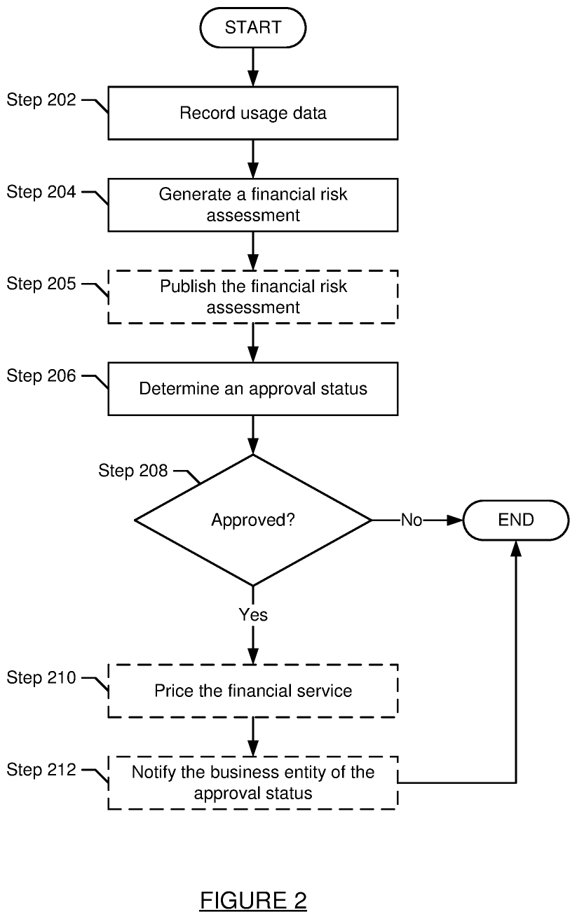

FIG. 2 shows a flowchart of a method for assessing financial risk associated with a business entity in accordance with one or more embodiments of the invention. In one or more embodiments, one or more of the steps shown in FIG. 2 may be omitted, repeated, and/or performed in a different order than the order shown in FIG. 2. Accordingly, the specific arrangement of steps shown in FIG. 2 should not be construed as limiting the scope of the invention.

In one or more embodiments, in Step 202, usage data associated with consumer business software is recorded. Specifically, the usage data describes consumer behavior associated with the consumer business software. As noted above, the term “consumer” refers to a business entity, or a designated agent thereof, to which the consumer business software is licensed. Further, as noted above, many different types of consumer behaviors may be recorded, and examples of consumer behaviors are discussed below.

In one or more embodiments, in Step 204, a financial risk assessment associated with the business entity is generated. Specifically, the financial risk assessment indicates a financial risk associated with doing business with the business entity. The financial risk assessment is based on an analysis of the usage data. Specifically, the usage data is analyzed to identify consumer behaviors that reflect the business entity's financial reliability. In other words, the consumer behaviors may indicate financial risk factors associated with the business entity. The financial risk assessment may be designed to provide information for financial service providers, potential business partners of the business entity, or both. In other words, the financial risk assessment may be used not only to evaluate the business entity for a financial service, but also to establish credibility between business partners. Some ways of communicating the financial risk assessment to potential business partners are discussed below.

In one or more embodiments, generating the financial risk assessment involves comparing the usage data with historical usage data associated with other business entities. For example, historical usage data for business entities in good financial standing may be used to generate a desirable usage profile, i.e., a set of consumer behaviors that are typical of business entities in good financial standing. Specifically, the desirable usage profile may indicate that reliable business entities frequently exhibit a particular type of consumer behavior. Conversely, historical usage data associated with defaulted or fraudulent business entities may be used to generate an undesirable usage profile. In one or more embodiments, generating the financial risk assessment involves comparing the usage data with a desirable usage profile and/or an undesirable usage profile. Similarities to a particular usage profile may indicate a similar level of financial risk.

Those skilled in the art will appreciate that normal business practices frequently differ from one industry to the next. Therefore, it may not make sense to hold business entities in all industries to the same standards. To address this concern, in one or more embodiments, historical usage data is filtered by industry, and usage data from the business entity in question is compared with historical usage data from the relevant industry. In other words, desirable usage profiles and/or undesirable usage profiles may be industry-specific. For example, some industries normally have high employee turnover, while other industries normally have low employee turnover. High turnover in a normally high-turnover industry may not be a cause for concern, but high turnover in a normally low-turnover industry may indicate a higher risk of financial default or fraud. Those skilled in the art will appreciate that many different types of industry-specific behaviors exist. Generally speaking, filtering historical usage data may improve the accuracy of the financial risk assessment.

In one or more embodiments, the financial risk assessment includes an alphanumeric value in a range of possible values. For example, a high value may indicate high financial risk, and a low value may indicate low financial risk, or vice versa. Alternatively, the financial risk assessment may include multiple values or indicators associated with different types of financial risk factors. Further, factors other than usage data may be included in the financial risk assessment. For example, the usage data may be combined with the business entity's FICO score. Those skilled in the art will appreciate that many different types of financial risk factors exist which may be included in the financial risk assessment. Further, those skilled in the art will appreciate that usage data indicating a likelihood of identity fraud may result in a very high risk assessment, and may even prompt the financial service provider to contact a law enforcement or consumer protection authority.

In one or more embodiments, in Step 205, the financial risk assessment is published for access by business partners of the business entity. For example, the financial risk assessment may be published in a business journal, on a website, or in a brochure. In one or more embodiments of the invention, the business entity may be allowed to choose which business partners (including potential business partners) have access to the financial risk assessment.

In one or more embodiments, publishing the financial risk assessment allows business partners to make informed decisions about dealing with the business entity. For example, a low-risk assessment may encourage business partners to deal with the business entity, while a high-risk assessment may serve as a warning to business partners. Further, the published risk assessment may include information about different types of business transactions, and business partners may be able to use the risk assessment to evaluate the business entity on a per-transaction basis. In one or more embodiments of the invention, business partners may also be able to provide feedback based on prior business transactions, and the feedback may be integrated into the business entity's risk assessment, thereby providing increased assurance that the risk assessment is reliable.

In one or more embodiments, in Step 206, an approval status associated with the business entity is determined. Specifically, the approval status indicates whether the business entity is approved to receive a financial service. For example, if the financial risk assessment is an alphanumeric value, then the approval status may be based on a minimum or maximum value required for approval. If the financial risk assessment includes multiple values, the approval status may be based on one or more of those values. Further, one or more values may be used as input to a financial formula to determine an approval status. For example, the financial formula may combine the financial risk assessment with the business entity's FICO score, historical earnings, projected earnings, or share price. Those skilled in the art will appreciate that many different financial values may be included when determining the business entity's approval status.

In one or more embodiments, in Step 208, the final approval status is examined. If the business entity is not approved to receive the financial service, then the method ends. Alternatively, if the business entity is approved to receive the financial service, then the approval status may be handled in many different ways. For example, the approval status may be handled according to one or more of Steps 210-212, discussed below. Alternatively, the approval status may simply be stored for future reference.

In one or more embodiments, in Step 210, the financial service is priced for the business entity based on the financial risk assessment. Specifically, the pricing may be proportional to a value included in the financial risk assessment. For example, as discussed above, a low value may indicate low financial risk. As a customer incentive, the financial service provider may offer lower prices to business entities with lower risk assessments. Conversely, the financial service provider may require higher prices for business entities with higher risk assessments. In one or more embodiments, dynamic pricing based on the financial risk assessment helps the financial service provider offer competitive pricing to reliable business entities while mitigating the financial risks associated with less reliable business entities. In the case of a merchant account, the price may also be based on the business entity's expected transaction volume. For example, business entities expecting high volumes may be offered discounted rates.

In one or more embodiments, in Step 212, the business entity is notified of the approval status. As discussed above, the business entity may be notified in response to an application to receive the financial service. Alternatively, the notification may indicate that the business entity is pre-approved to receive the financial service. If dynamic pricing (discussed above) is used, then the notification may take the form of a promotional sales pitch. Further, although embodiments of the invention discussed herein relate primarily to business entities that are not already receiving the financial service, embodiments of the invention may also be used to adjust the cost of the financial service for an existing customer. For example, if the business entity grows in size or reduces its financial risk factors over time, the financial service provider may choose to approve the business entity for a lower pricing scheme.

As discussed above, many different types of consumer behaviors may be recorded as usage data and contribute to the financial risk assessment. The following is a discussion of examples of consumer behaviors, along with examples of how these consumer behaviors may contribute to a financial risk assessment. The following discussion is provided for exemplary purposes only; many different types of consumer behaviors exist, and the consumer behaviors discussed herein may be interpreted in many different ways.

For example, the usage data may describe how long the business entity (or designated agent thereof) has been using the consumer business software. Long-term usage may indicate that the business entity is both legitimate and reliable; fraudulent business entities are not likely to use the consumer business software for an extended period of time prior to engaging in fraud.

Another example involves usage data describing how often the business entity (or designated agent thereof) accesses the consumer business software. Specifically, frequent access may indicate an active concern with the business entity's operations, which may provide some assurance that the business entity is financially responsible. For example, if the consumer business software is financial management software, frequent access may indicate an active involvement in the business entity's finances, which may be a good indicator of fiscal responsibility. Conversely, infrequent access, or decreasing access over time, may indicate increasing financial risk.

Another example involves using the consumer business software to track the business entity's customers (for example, CRM software), the usage data may describe how many customers the business entity has. A large number of customers stored in the consumer business software may indicate a stable business and high financial reliability. Conversely, few customers, or a fluctuating number of customers, may indicate financial instability.

As another example, if the consumer business software includes information about the business entity's products (for example, supply chain management software), the usage data may describe how many products the business entity offers for sale. A large number of products may indicate an established business and high financial reliability. Conversely, few products, or a fluctuating number of products, may indicate financial instability.

As another example, if the consumer business software includes information about the business entity's sales and/or purchases (for example, point-of-sale transaction software), the usage data may describe the volume and/or frequency rate of payment transactions. High sales volume and/or frequent sales may indicate a flourishing business with consistent income, thereby providing some assurance that the business entity is financially reliable.

As another example, if the consumer business software includes information about the business entity's finances (for example, financial management software), the usage data may indicate the business entity's cash flow status, i.e., the business entity's profitability (or lack thereof) over time. Consistently strong cash flow may indicate low financial risk, while infrequent or negative cash flow may indicate higher financial risk.

As another example, if the consumer business software includes information about the business entity's business partners (for example, CRM or supply chain management software), the usage data may indicate how many business partners the business entity has had. Consistent long-term partnerships may indicate financial stability and good business practices, while changing or diminishing partnerships may indicate financial instability or poor business practices. Further, if a business partner feedback mechanism (discussed above) is used, the usage data may describe business partners' opinions of the business entity. Positive opinions may indicate a higher degree of reliability than negative opinions.

As another example, if the consumer business software includes information about the business entity's finances, the usage data may indicate whether the business entity uses an accountant, a tax specialist, or another type of financial agent. A fraudulent business entity is unlikely to share its financial records with a financial authority. Therefore, this type of sharing may provide increased assurance that the business entity is not fraudulent.

As another example, if the consumer business software includes information about the business entity's finances, the usage data may indicate whether the business entity consistently pays state or federal taxes. Fraudulent business entities are more likely to evade taxes. Therefore, a strong tax record may provide increase assurance that the business entity is not fraudulent.

As another example, if the business entity has submitted an application to receive the financial service, the usage data may indicate whether the application originated from the consumer business software, or another trusted source. A trusted source may provide increased assurance that the application does not include incorrect or fraudulent information. Therefore, the information in the application may be more reliable for assessing the business entity's eligibility to receive the financial service.

In one or more embodiments of the invention, one or more of the consumer behaviors discussed above may be combined to provide a more detailed understanding of the business entity's financial risk. For example, a business entity that has many customers, strong cash flow, regularly pays its taxes, and accesses the consumer business software frequently may be considered an extremely low financial risk. Conversely, a business entity that has fluctuating levels of business transactions, multiple tax extensions, and accesses the consumer business software irregularly may be considered an extremely high financial risk, and may even be suspected of fraud. In view of the discussion above, those skilled in the art will appreciate that consumer behaviors may be combined in many different ways to assess the financial risk associated with a particular business entity. Further, different consumer behaviors may be used to evaluate different types of business entities.

In one or more embodiments, the method and system described herein provide improved financial risk assessment prior to approving or denying a business entity to receive a financial service. Behavior is generally more difficult to manipulate or fabricate than raw data. Therefore, embodiments of the invention provide reliable usage data that may be used to supplement or replace traditional financial service application processes. Further, for business entities demonstrating very low financial risk, embodiments of the invention may allow financial service providers to forgo traditional safety measures such as irrevocable funds, letters of credit, traditional underwriting, and bank guarantees. Generally speaking, embodiments of the invention increase the accuracy of financial service providers' decisions to approve or deny financial services to business entities, thereby minimizing the amount of financial risk assumed by the financial service providers.

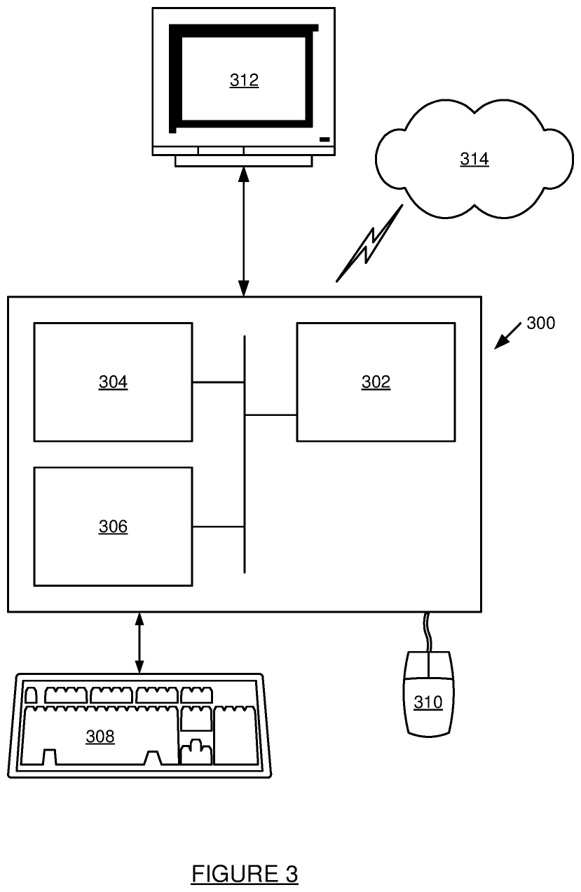

Embodiments of the invention may be implemented on virtually any type of computer regardless of the platform being used. For example, as shown in FIG. 3, a computer system (300) includes a processor (302), associated memory (304), a storage device (306), and numerous other elements and functionalities typical of today's computers (not shown). The computer (300) may also include input means, such as a keyboard (308) and a mouse (310), and output means, such as a monitor (312). The computer system (300) may be connected to a network (314) (e.g., a local area network (LAN), a wide area network (WAN) such as the Internet, or any other similar type of network) via a network interface connection (not shown). Those skilled in the art will appreciate that these input and output means may take other forms.

Further, those skilled in the art will appreciate that one or more elements of the aforementioned computer system (300) may be located at a remote location and connected to the other elements over a network. Further, embodiments of the invention may be implemented on a distributed system having a plurality of nodes, where each portion of the invention (e.g., consumer business software, financial service provider, risk assessment service, risk analysis logic, usage data, approval logic, pricing logic, etc.) may be located on a different node within the distributed system. In one embodiment of the invention, the node corresponds to a computer system. Alternatively, the node may correspond to a processor with associated physical memory. The node may alternatively correspond to a processor with shared memory and/or resources. Further, software instructions to perform embodiments of the invention may be stored on a computer readable medium such as a compact disc (CD), a diskette, a tape, a file, or any other computer readable storage device.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1.-25. (canceled)

26. A method comprising:
monitoring, by a software application, usage of the software application by an entity to store a plurality of usage data,
wherein the plurality of usage data describes a behavior associated with the software application, and
wherein monitoring usage data comprises a web server:
receiving a plurality of network requests from users of a website via a network, and
recording, in the plurality of usage data, a destination uniform resource locator (URL) in the plurality of network requests;
extracting, from historical usage data, a first subset of the historical usage data from a plurality of entities having a first behavior type;
generating a first profile of the first behavior type from the first subset of the historical usage data;
extracting, from the historical usage data, a second subset of the historical usage data from a plurality of entities having a second behavior type;
generating a second profile of the second behavior type from the second subset of the historical usage data;
comparing, by the software application, the plurality of usage data with the first profile and the second profile to generate a comparison identifying the particular type of the behavior;
generating, by the software application, a risk assessment associated with the entity based on the particular type of behavior in the comparison;
determining, by the software application, an approval status based on the risk assessment, the approval status indicating whether the entity is approved to receive a service; and
notifying the entity of the approval status.

27. The method of claim 26, further comprising verifying the approval status using a neural network.

28. The method of claim 26, wherein the plurality of usage data comprises an amount of storage by the software application for the entity.

29. The method of claim 26, wherein the plurality of usage data comprises a fluctuation of storage by the software application for the entity.

30. The method of claim 26, wherein the plurality of usage data comprises a frequency of storage by the software application for the entity.

31. The method of claim 26, wherein the plurality of usage data comprises a fluctuation in a number of records stored by the software application.

33. The method of claim 26, wherein the plurality of usage data comprises at least one selected from a group consisting of a lifetime usage duration, a usage frequency, a number of records stored by the software application, and a historical consistency of information stored by the software application.

34. A computer system comprising:
a software application used by an entity and executing on a processor, the software application configured to:
monitor usage of the software application by an entity to store a plurality of usage data,
wherein the plurality of usage data describes a behavior associated with the software application, and
wherein monitoring usage data comprises a web server:
receiving a plurality of network requests from users of a website via a network, and
recording, in the plurality of usage data, a destination uniform resource locator (URL) in the plurality of network requests; and
a risk assessment service configured to:
extract, from historical usage data, a first subset of the historical usage data from a plurality of entities having a first behavior type,
generate a first profile of the first behavior type from the first subset of the historical usage data,
extract, from the historical usage data, a second subset of the historical usage data from a plurality of entities having a second behavior type,
generate a second profile of the second behavior type from the second subset of the historical usage data,
compare, by the software application, the plurality of usage data with the first profile and the second profile to generate a comparison identifying the particular type of the behavior,
generate, by the software application, a risk assessment associated with the entity based on the particular type of behavior in the comparison, and
determine, by the software application, an approval status based on the risk assessment, the approval status indicating whether the entity is approved to receive a service.

35. The computer system of claim 34, wherein the risk assessment service is further configured to verify the approval status using a neural network.

36. The computer system of claim 34, wherein the plurality of usage data comprises an amount of storage by the software application for the entity.

37. The computer system of claim 34, wherein the plurality of usage data comprises a fluctuation of storage by the software application for the entity.

38. The computer system of claim 34, wherein the plurality of usage data comprises a frequency of storage by the software application for the entity.

40. The computer system of claim 34, wherein the plurality of usage data comprises at least one selected from a group consisting of a lifetime usage duration, a usage frequency, a number of records stored by the software application, and a historical consistency of information stored by the software application.

41. A non-transitory computer-readable medium comprising executable instructions that perform operations comprising:
monitoring, by a software application, usage of the software application by an entity to store a plurality of usage data,
wherein the plurality of usage data describes a behavior associated with the software application, and
wherein monitoring usage data comprises a web server:
receiving a plurality of network requests from users of a website via a network, and
recording, in the plurality of usage data, a destination uniform resource locator (URL) in the plurality of network requests;
extracting, from historical usage data, a first subset of the historical usage data from a plurality of entities having a first behavior type;
generating a first profile of the first behavior type from the first subset of the historical usage data;
extracting, from the historical usage data, a second subset of the historical usage data from a plurality of entities having a second behavior type;
generating a second profile of the second behavior type from the second subset of the historical usage data;
comparing, by the software application, the plurality of usage data with the first profile and the second profile to generate a comparison identifying the particular type of the behavior;
generating, by the software application, a risk assessment associated with the entity based on the particular type of behavior in the comparison;
determining, by the software application, an approval status based on the risk assessment, the approval status indicating whether the entity is approved to receive a service; and
notifying the entity of the approval status.

42. The non-transitory computer readable medium of claim 41, wherein the executable instructions further perform verifying the approval status using a neural network.

43. The non-transitory computer readable medium of claim 41, wherein the plurality of usage data comprises an amount of storage by the software application for the entity.

44. The non-transitory computer readable medium of claim 41, wherein the plurality of usage data comprises a fluctuation of storage by the software application for the entity.

45. The non-transitory computer readable medium of claim 41, wherein the plurality of usage data comprises a frequency of storage by the software application for the entity.
